(19) United States
(12) Patent Application Publication
(10) Pub. No.: US 2007/0136348 A1
(43) Pub. Date: Jun. 14, 2007

(54) Screen-wise presentation of search results

(75) Inventor: Frank Uittenbogaard, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/576,667

(22) PCT Filed: Oct. 21, 2004
(86) PCT No.: PCT/IB04/52159

§ 371 Date: Apr. 21, 2006

(30) Foreign Application Priority Data
Oct. 27, 2003 (EP) 03103971.2

(51) Int. Cl. G06F 7/00

(52) U.S. Cl. 707/102

(57) ABSTRACT

The invention relates to a method of presenting results of searching a document (200, 300). Occurrences (230, 240) found in a part of the document (210, 310) are presented to the user on one screen. In a subsequent step, a further part of the document (220, 320), comprising at least one further hit (230, 240) which has not been presented, may be displayed on the same screen. Thus, all occurrences found in the document are presented to the user only once.

The invention relates to a method of presenting results of a searching a document, the search result comprising a hit in the document. The invention also relates to an apparatus for presenting results of searching a document, and to a computer program product.

Document EP 0596247 discloses a method of searching keywords in the text information. A user can initiate a search using a search string to find occurrences of the search string from a particular document. A computer produces a hit list of documents and pages that contain the search string. Once the user selects a page on the hit list, the computer displays the page and highlights hits within the selected page. The user may use navigation keys to move to the next hit or the previous hit displayed on the page.

Occurrences of the search string can be distributed arbitrarily in the document. Some of the occurrences may be clustered, e.g. in a section of the document where the search string often occurs. In another example, a particular section of the document may comprise only a few occurrences.

If the user uses know “find next” or “find previous” commands to browse through the occurrences, it may be difficult for the user to determine whether a particular occurrence is in the current cluster or in a different part of the document. If the user simply scrolls the document to see the occurrences, it may be very time-consuming. Thus, the known method is inefficient in presenting occurrences to the user.

It is an object of the present invention to obviate the drawbacks of the prior-art search methods, and to provide a method of presenting results of searching a document, which enables the user to navigate easily and efficiently among the search results.

This object is realized in that the method comprises the steps of:

presenting at least one hit in a part of the document displayed on a screen, and

subsequently presenting at least one further hit in a further part of the document displayed on the same screen, at least one further hit not being comprising in said part of the document which has been displayed.

Generally, many documents are too large to be viewed entirely on a single screen without sacrificing readability. A common element of most browsing systems is that a document can be viewed screen-wise, i.e. a part of the document is shown on the screen at a time. The part of the document displayed on the screen may be a paragraph, several paragraphs, a page or several pages of said document. For example, the page may comprise a number of lines and columns of a text document.

All search hits, i.e. occurrences found upon the search, which are currently on the screen are presented to the user, e.g. by visually highlighting using some color, so that they are simultaneously presented to the user. Of course, it may happen that only one hit is found and presented on the screen.

To display a further occurrences or occurrences in the document, which are not shown on the current screen, the document may be browsed screen-wise, i.e. step-wise, wherein one screen is shown at each step. Thus, a subsequent screen with the further part of the document is displayed. The further part of the document comprises at least one further hit in said further part of the document which has not yet been presented.

For example, in contrast to the known text browsing methods, a “find next” command will not start searching for and highlighting the next occurrence, but instead, the further page comprising the occurrence or the occurrences which have not yet been presented is displayed.

According to the invention, as few screens as possible are displayed in order to present the search results, i.e. screen-wise navigated, and the user is provided with an overview of all search results on each screen. The user gets a clear overview of the distribution of occurrences, and recognizes clusters at a glance. For example, the repeated find-commands do not result in unpredictable small jumps on the current screen, but show only occurrences of the search string which the user has not seen yet. A few “find next” is especially useful for a device with a limited user interface, e.g. a mobile phone, portable computer, a remote control unit, etc. The user can browse through the search results with few commands.

The object of the present invention is also realized in that the invention provides an apparatus for presenting results of searching a document, the search results comprising at least one hit in the document, wherein the apparatus comprises a display means coupled to a processor for enabling the apparatus:

to present at least one hit in a part of the document displayed on a screen, and

to present subsequently at least one further hit in a further part of the document displayed on the same screen, at least one further hit not being comprised in said part of the document which has been displayed.

The apparatus is arranged to function as described above with reference to the method of the present invention.

These and other aspects of the invention will be further explained and described with reference to the following drawings:

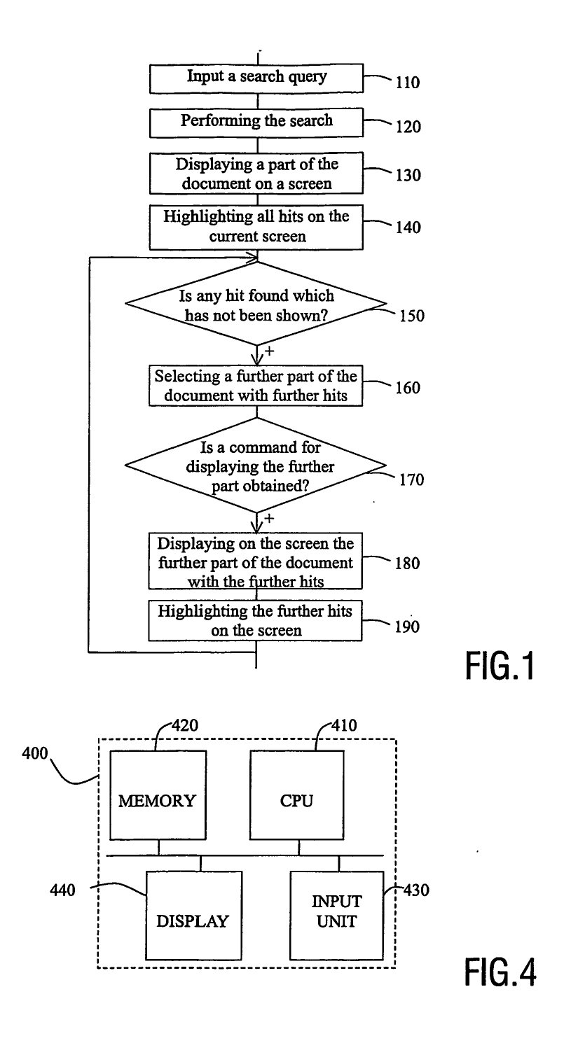

FIG. 1 shows an embodiment of the method of the present invention;

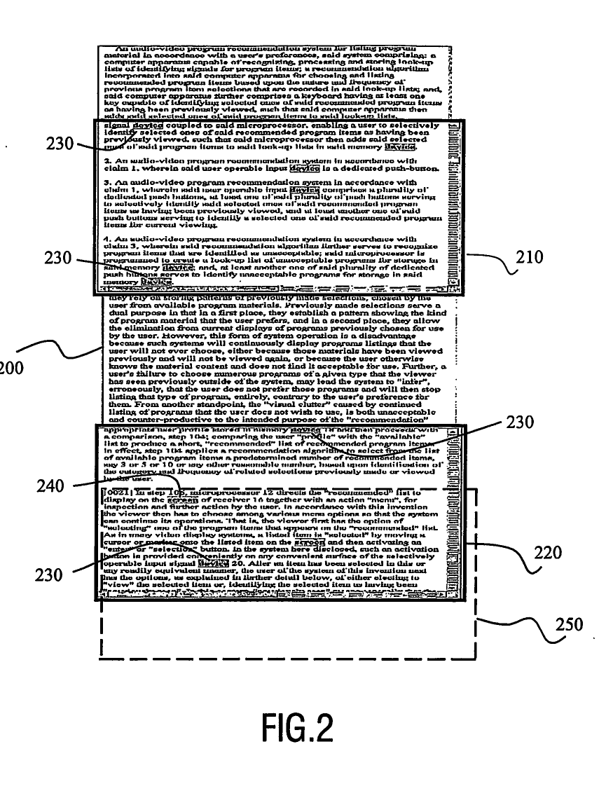

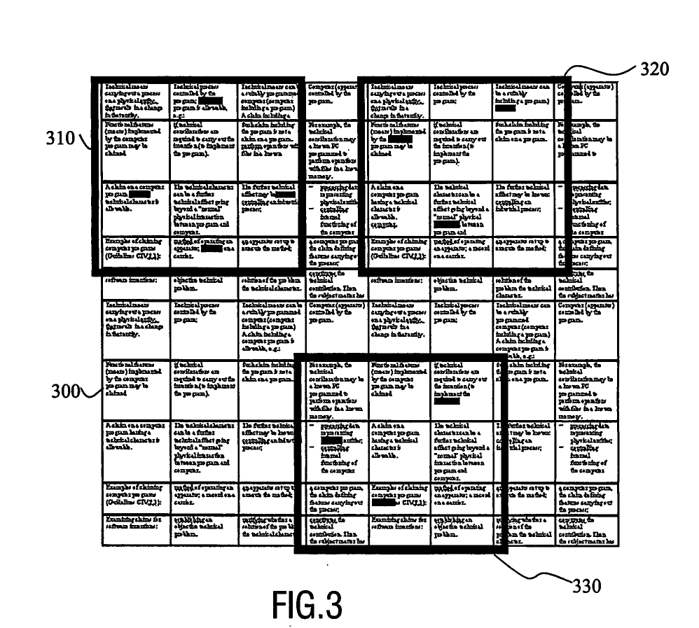

FIGS. 2 and 3 show a diagram illustrating examples of screens displaying parts of a document with found search results;

FIG. 4 shows a functional block diagram of an embodiment of an apparatus according to the invention.

FIG. 1 shows an embodiment of the method of presenting search results of a document according to the present invention. Generally, the invention can be used to present results of searching any information which can be searched, using, for example, a computer, and displayed or presented otherwise to a user. In this context, a “document” may comprise any combination of information such as text, video images, photos, graphics, audio data and other digital data such, e.g. meta-data according to the MPEG-7 standard which may be used to describe and search digitized materials by means of sampling, as well as by using lexical search terms. The audio data may be in formats like the MPEG-2 standard (Moving Picture Experts Group), AVI (Audio Video Interleave) format, WMA (Window Media Audio) format, etc. The video data may be in formats like GIF (Graphic Interchange Format), JPEG (Joint Photographic Experts Group), MPEG-4, etc. The text information may be, for example, in the ASCII (American Standard Code for Information Interchange) format, PDF (Adobe Acrobat Format) format, HTML (HyperText Markup Language) format. As another example, the meta-data may be in the XML (Extensible Markup Language) format. Thus, the wording “document” is not limited to text documents.

A search query for searching the document may first be obtained at step 110. In text documents, the search may be initiated with a dialogue window for inputting the search string and various search options.

Using the query, the search is performed at step 120. There are many known methods of searching documents on the basis of the text query. Upon the search, occurrences of the search string may be found. One of the methods is described in EP 0 596 247, where images are analyzed to obtain a text index which is then searched as conventional text information. The same or similar techniques as for searching the text information may be applied for searching the meta-data or data structures.

At step 130, a part of the document comprising at least one found occurrence, i.e. at least one hit, is displayed on a screen. The part of the document is entirely displayable on the screen so that the user can see the content of said part.

The hits in the displayed part of the document may subsequently be presented to the user in different ways at step 140. For example, the search strings found in the text may be visually highlighted.

At step 150, it may be checked whether there are any further hits, i.e. the further search results, in the document which have not been presented yet. If the further hit or hits successive with respect to the part of the document which has been displayed are found (e.g. after a subsequent search), a further part of the documents with the further search results may be selected at step 160. For example, the beginning and the end of the further part are determined. The wording “successive” means that the further occurrences may not be comprised in the part of the document which has been displayed.

A command for displaying the further part of the document may be awaited from the user at step 170. Alternatively, the command may be generated automatically and the user input may be dispensed with.

At step 180, the further part of the document with the further search results may be displayed, and, at step 190, the further search results may be presented, e.g. visually highlighted, as described above with reference to steps 130 and 140.

Steps 150 to 190 may be iterated if other further occurrences are found in the document.

An embodiment of the method of the present invention is explained with reference to FIG. 2. FIG. 2 shows a screen 210 and a screen 220 in which a first part of the document 200 and a second part of the document 200, i.e. the further part of the document, are shown, respectively. The first screen 210 comprises occurrences of a first text string 230. The second screen 220 comprises occurrences of the same first text string 230 and occurrences of a second text string 240.

It should be noted that the part of the document which is displayed may be different from a logical page, e.g. a conventional “page” in a text MS Word document. For example, this logical page may merely indicate a part of the document which is intended for printing.

First, the screen 210 is displayed with the occurrences of the first string 230. The second screen 220 is subsequently displayed with the further occurrences of the first string 230 and the second string 240. The second screen 220 excludes the occurrences in the first screen 210. The screens 210 and 220 may be displayed on the same device, in the same area.

Other parts of the document 200 which do not comprise any search results are not displayed. The user may be provided with all search results in two screens displayed automatically or upon the user command, e.g. the “find next” command. Normally, each occurrence is presented only once, except in some special circumstances, for example, when the end of the document is reached.

The screen 210 may be aligned, with respect to the found occurrences in the corresponding part of the document, so that a maximum of the occurrences is shown on the same screen. For instance, FIG. 2 shows that the screen 210 is aligned to present one occurrence 230 at the top of the screen. As a result, the other occurrence is presented at the bottom of the screen 210. This would not be possible if the occurrences at the top were, for example, in the middle of the screen 210. Generally, the screen may be aligned in any direction depending on the document, e.g. upward, downward, left or right.

In one of the embodiments of the present invention, there are two or more search queries, for example, the search text strings 230 and 240 as shown in FIG. 2. The search results for one or more of the search queries may be presented simultaneously. For instance, the search results for only one search query may be presented, whereas the search results for the other queries may be shown as long as they occur on the same screen with the former results. A part of the document to be displayed may be selected on the basis of this choice of whether to present search results for one or more of the search queries. For example, in FIG. 2, the screen 220 would be shifted (aligned) to a position 250 if only occurrences for the search string 240 are to be shown.

Certain documents may have a complex structure such as a table, a tree-structure, etc. Tree-structured documents may be used in EPG (Electronic Program Guide) systems, TV recommenders (e.g. genre hierarchies), file directories in audio jukeboxes and cameras, database reports, etc. In this case, the search results cannot be viewed just by scrolling the document from top to bottom, for example. Multiple scrolling directions may be required, for example, in the table or the tree-like structure where three branches extend beyond the screen boundaries in horizontal or vertical directions. This may cause the document to be scrolled alternately in different directions, e.g. upward, downward, left or right. This may be confusing for the person viewing the document.

An example of applying the method according to the present invention to the document comprising table-like information 300 is explained with reference to FIG. 3. FIG. 3 shows screens 310, 320 and 330 in which corresponding parts of the document 300 are displayed. Other parts of the document may be skipped and not shown to the user. The hits are shown only once in the respective screens. The screens are not adjacent, as would be the case in conventional systems, but positioned to show the search results according to the method of the invention.

It may happen that in tables like table 300, the text in cells cannot be shown completely and is hidden or truncated. However, occurrences may be found in such cells, and such occurrences may not be visible because they are in the hidden part of the text in the cell. This has the disadvantage that it is not clear at first sight which part of the cell matches the search string. To solve this problem, the occurrences may be shown in the following manner. A first part, which is visible, of the text in the cell may be shown if the search string occurs within the first part. If the occurrences are in the hidden part of the text of the cell, a part of the text in which the occurrences are found is shown, and the other part of the text may be skipped (not shown). The skipped part of the text in the cell may be represented by special symbols like “. . . ”, etc.

A further embodiment of the present invention relates to documents which may be edited. Known text processors allow replacing one found occurrence at a time. When a particular occurrence is highlighted on the screen, a subsequent typing, press of a button or the like may cause the highlighted occurrence to be replaced by input characters. It is also known to replace all occurrences in the whole document. Thus, the user may be required to act on every occurrence found in the document, which is time-consuming, or to replace the occurrences in the whole document, which is not desirable because the user cannot see the whole document. To solve this problem, the method of the present invention may provide replacing all occurrences on the current screen by a single command, press of the button, etc.

FIG. 4 shows a block diagram illustrating an apparatus 400 for presenting results of searching a document. The apparatus may comprise a central processing unit (CPU) 410, a memory 420, an optional input unit 430 and a display device 440.

The display device may be a monitor such as a conventional CRT, or any other device arranged to display the document and the search results on the screen. The user input unit may be a keyboard, a pointer control device such as a computer mouse, etc. The input unit may be equipped with cursor control keys, for example, a LEFT key, a RIGHT key, an UP key and a DOWN key. In another example, the input unit may be combined with the display device and comprise a touch-sensitive screen. In a further example, the input unit may comprise a microphone (not shown) and a speech recognition facility, typically implemented as a software program to be executed by the CPU. The display device may be coupled to speakers (not shown) for reproducing the audio information.

The memory, e.g. a conventional Random Access Memory (RAM), may be arranged to store a computer program to be executed by the CPU for enabling the CPU to function as described above with reference to the method of the present invention. The memory may also be arranged to store the document, and the CPU may be arranged to access the document stored in the memory for performing the search. The CPU may be a general-purpose microprocessor unit. It will be clear to the skilled person how to implement the present invention in the apparatus.

The CPU may be coupled to a communication unit (not shown) arranged to obtain the document from an external source. For example, the communication unit may be a well-known modem intended for connection to the Internet, or a communication port for obtaining the document from a scanner.

It should be understood that the present invention is not restricted to a particular embodiment shown in FIG. 4 but may also be implemented in a TV set, a home cinema system, a portable video player, a remote control unit or a mobile phone, as well as in a conventional computer.

The various program products may implement the functions of the device and method of the present invention and may be combined in several ways with the hardware or located in different other devices. Variations and modifications of the described embodiment are possible within the scope of the inventive concept.

For instance, the method of the present invention is explained above with the examples referring to the text search in documents. However, the invention is applicable to audio and video information.

The search query may also be an audio query, video query or any combination thereof with the text query. The video information may be searched by using different methods. For example, video data to be searched may be pre-marked, using tags, so-called meta-data, using, for example, the MPEG-7 standard in the known manner. Such video data may be searched in a conventional way, e.g. by using keywords.

In another example, the video information may be searched by applying various video analyses. Some methods of video analyses include steps such as segmentation of the video data, classification, and recognition, for example, recognition of frontal views of human faces. Other methods obtain the video query, e.g. a video clip or a still image, of a size much smaller than the searched video information to find parts of the video information that match the video query, using special algorithms with some measure of quality of match. For example, the algorithms may utilize image similarity measures after the video images have been split into blocks, or video similarity measures to measure similarity of clips. These known methods are applicable to searching video databases.

Many methods of searching audio information are known. The meta-data may be used to tag audio information (such as title, date of recording, subject, or person). Upon a specific text search query, specific data from the searched audio information may be retrieved. In another method, the audio information may be converted to text that can be searched very quickly for occurrences of a specified keyword or keywords. In another retrieval technique, the keyword may be presented by audio parameters for performing the search directly on the audio information.

Other techniques provide the use of pre-processing algorithms to describe the predetermined characteristics of the audio information, for example, representing a phonetic content of the audio information. During pre-processing, auxiliary data is created that is subsequently searched when a search query is input. If the search query is the text, it may be converted or represented by search audio parameters that are used to search the auxiliary data. The search query may also be audio data which are analyzed to obtain similar search audio parameters.

The hits found in the part of the video information or audio information may subsequently be presented to the user in different ways. For example, the image found in the video information may be provided with a border or edge of a certain color. The found piece of audio information, where the piece includes the audio hits, e.g. two pronounced words, matching the audio query, may be reproduced. In this case, the audio piece is longer in time than the audio hits. The audio hits may be recognized in the audio piece by, for example, special audio markings like pre-determined sounds corresponding to “a beginning of the found hit” and “an end of the found hit”.

The use of the verb ‘to comprise’ and its conjugations does not exclude the presence of elements or steps other than those defined in a claim. The invention can be implemented by means of hardware comprising several distinct elements, and by means of a suitably programmed computer. In the device claim enumerating several means, several of these means can be embodied by one and the same item of hardware.

1. A method of presenting results of searching a document (200, 300), the search result comprising a hit in the document, wherein the method comprises the steps of:
(130, 140) presenting at least one hit (230, 240) in a part of the document (210, 310) displayed on a screen, and
(180, 190) subsequently presenting at least one further hit (230, 240) in a further part of the document (220, 320) displayed on the same screen, at least one further hit (230, 240) not being comprised in said part of the document (210, 310) which has been displayed.

2. The method of claim 1, wherein the further part of the document excludes search results which have been presented.

3. The method of claim 1, wherein said document is one of an electronic text document (200, 300), a data structure, video or audio information.

4. The method of claim 1, wherein the document is presented page-wise, and the part of the document corresponds to a page entirely displayable on the screen.

5. The method of claim 1, wherein the hits are visually marked on the screen.

6. The method of claim 1, further comprising a step of replacing an element of the document corresponding to a particular hit presented on the screen, or a step of replacing simultaneously all elements of the document corresponding to all hits presented on the screen.

7. The method of claim 1, further comprising a step of aligning the presentation of the hits upward, downward, left or right to allow a maximum number of hits to be simultaneously shown on the screen.

8. The method of claim 1, wherein at least two search queries are obtained for searching the document, and the parts of the document to be displayed are correspondingly selected to present search results for one or more of the search queries.

9. An apparatus (400) for presenting results of searching a document (200, 300), the search results comprising at least one hit in the document, wherein the apparatus comprises a display means (440) coupled to a processor (410) for enabling the apparatus:
to present search results (230, 240) in a part of the document (210, 310) displayed on a screen, and
subsequently to present at least one further hit (230, 240) in a further part of the document displayed on the same screen, wherein the further part of the document (220, 320) excludes the search results which have been presented, at least one further hit (230, 240) not being comprised in said part of the document (210, 310) which has been displayed.

10. A consumer electronics product being one of a TV set, a home cinema system, a portable video player, a remote control unit or a mobile phone, the product comprising an apparatus as claimed in claim 9.

11. A computer program product enabling a programmable device, when executing said computer program product, to function as the apparatus as defined in claim 9.
